(19) United States
(12) Patent Application Publication
(10) Pub. No.: US 2024/0149942 A1
(43) Pub. Date: May 9, 2024

(54) STEER-BY-WIRE TYPE STEERING APPARATUS

(71) Applicant: HITACHI ASTEMO, LTD., Hitachinaka-shi, Ibaraki (JP)

(72) Inventor: Atsushi HIRATA, Hitachinaka-shi, Ibaraki (JP)

(73) Assignee: HITACHI ASTEMO, LTD., Hitachinaka-shi, Ibaraki (JP)

(21) Appl. No.: 18/549,233

(22) PCT Filed: Dec. 29, 2021
(86) PCT No.: PCT/JP2021/049019

§ 371 Date: Sep. 6, 2023

(30) Foreign Application Priority Data
Mar. 10, 2021 (JP) 2021-037976

(51) Int. Cl. B62D 6/00

(52) U.S. Cl. CPC B62D 6/008

(57) ABSTRACT

A steer-by-wire type steering apparatus includes a steering input device; a steering device; and a control device. The steering input device includes a reaction force actuator configured to apply steering reaction force to a steering operation input member. The steering device includes a steering actuator configured to cause steered road wheels to be steered through a steering member. The control device includes a reaction force actuator output amount decrease unit configured to decrease an output amount of the reaction force actuator when a deviation between an operation amount of the steering operation input member and a steering amount of the steering member increases and vehicle speed of a vehicle increases. This can prevent the steering operation input member from being abruptly moved in spite of a collision of the steered road wheels with an obstacle or other factors at the time of high vehicle speed.

### TECHNICAL FIELD

The present invention relates to a steer-by-wire type steering apparatus.

### BACKGROUND ART

A vehicular steering apparatus in Patent Document 1 is a vehicular steer-by-wire type steering apparatus. In the vehicular steer-by-wire type steering apparatus, a steering mechanism and a turning mechanism are mechanically separate. The steering mechanism includes a reaction force motor that applies reaction torque to a steering wheel. The turning mechanism includes a turning actuator that drives a turning shaft. A coupling mechanism that couples the steering mechanism and the turning mechanism is configured as an electric linkage mechanism. The vehicular steer-by-wire type steering apparatus includes turning shaft position control means, regulation necessity determination means, and steering regulation means. The turning shaft position control means causes a position of the turning shaft to follow a target position determined on the basis of the turning angle of the steering wheel. The regulation necessity determination means determines, on the basis of an output made from the turning actuator to the turning shaft and the turning speed of the turning shaft, whether to regulate a steering operation of a driver on the steering wheel or not. The steering regulation means increases a value of the reaction torque and regulates the steering operation when the regulation necessity determination means determines that the steering operation is to be regulated.

The vehicular steering apparatus in Patent Document 1 then appropriately informs the driver that a turning wheel abuts a curb or the like when the turning wheel abuts the curb or the like.

### REFERENCE DOCUMENT LIST

### Patent Document

Patent Document 1: JP 2006-298223 A

### SUMMARY OF THE INVENTION

### Problem to be Solved by the Invention

Incidentally, for example, a collision of steered road wheels (front wheels) with an obstacle such as a curb on a road shoulder at the time of a vehicle having a higher vehicle speed causes great steering reaction torque to be applied to the steering wheel (i.e., steering kickback increases). This may abruptly move the steering wheel, shocking the driver.

An object of the present invention, which has been made in view of the conventional situation, is to provide a steer-by-wire type steering apparatus capable of preventing a steering wheel from being abruptly moved, shocking the driver in spite of a collision of steered road wheels with an obstacle or other factors at the time of a vehicle having high vehicle speed.

### Means for Solving the Problem

According to an aspect of the present invention, a steer-by-wire type steering apparatus that is attached to a vehicle includes: a steering input device; a steering device; and a control device. The steering input device includes a steering operation input member, and a reaction force actuator configured to apply given steering reaction force to the steering operation input member. The steering device includes a steering member, and a steering actuator configured to cause steered road wheels to be steered through the steering member. The control device includes a vehicle speed acquisition unit configured to acquire vehicle speed information of the vehicle, a reaction force actuator control unit configured to control an output amount of the reaction force actuator, a steering actuator control unit configured to control the steering actuator in response to an operation on the steering operation input member, a deviation recognition unit configured to recognize a deviation between an operation amount of the steering operation input member and a steering amount of the steering member, and a reaction force actuator output amount decrease unit configured to decrease the output amount of the reaction force actuator when the deviation recognized by the deviation recognition unit increases and vehicle speed of the vehicle increases. The output amount is controlled by the reaction force actuator control unit.

### Effect of the Invention

According to the present invention, it is possible to prevent a steering wheel from being abruptly moved, shocking the driver, in spite of a collision of steered road wheels with an obstacle or other factors at the time of a vehicle having high vehicle speed.

### BRIEF DESCRIPTION OF THE DRAWINGS

FIG. 1 is a system configuration diagram of a steer-by-wire type steering apparatus.

FIG. 2 is a functional block diagram of a steering control device.

FIG. 3 is a block diagram more specifically illustrating a procedure of controlling steering reaction torque and a procedure of controlling a steering angle.

FIG. 4 is a block diagram illustrating a first embodiment of a road surface reaction force calculation unit.

FIG. 5 is a block diagram illustrating a second embodiment of the road surface reaction force calculation unit.

FIG. 6 is a diagram for describing a correlation between a threshold in a conversion processing section for determining whether an angular deviation α increases and vehicle speed.

### MODE FOR CARRYING OUT THE INVENTION

The following describes embodiments of a steer-by-wire type steering apparatus according to the present invention in view of the drawings.

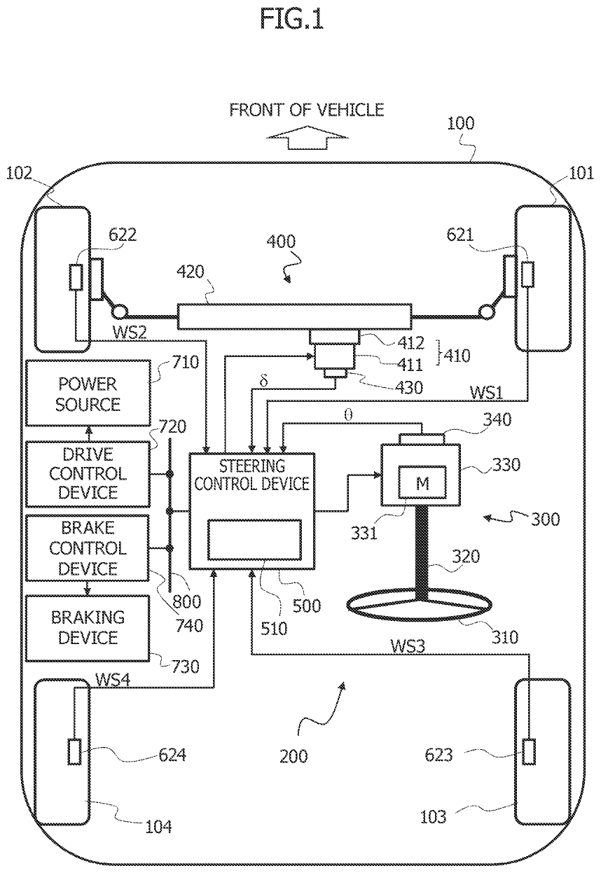

FIG. 1 is a system configuration diagram illustrating an aspect of a steer-by-wire type steering apparatus 200 attached to a vehicle 100 that is a four-wheeled automobile.

Steer-by-wire type steering apparatus 200 is a steering system in which front wheels 101 and 102 (i.e., front tires) and a steering wheel 310 are mechanically separated. Front wheels 101 and 102 are steered road wheels. Steering wheel 310 serves as a steering operation input member.

Steering apparatus 200 then includes a steering input device 300 including steering wheel 310, a steering device 400 that steers front wheels 101 and 102, and a steering control device 500. Steering control device 500 is a control device that controls steering input device 300 and steering device 400.

Steering input device 300 includes steering wheel 310, a steering shaft 320, a reaction force actuator 330, and an operation angle sensor 340.

Steering shaft 320 rotates while linking to the rotation of steering wheel 310, but steering shaft 320 is mechanically separated from front wheels 101 and 102.

Reaction force actuator 330 is a device that applies given steering reaction force to steering wheel 310 by using a motor 331. Reaction force actuator 330 includes a torque damper, an operation angle limiting mechanism, a reducer, and the like in addition to motor 331.

It is to be noted that motor 331 is, for example, a 3-phase brushless motor.

Steering input device 300 includes reaction force actuator 330. This causes steering wheel 310 to be rotated by a difference between operation torque and steering reaction torque. The operation torque is applied by the driver of vehicle 100 performing a steering operation on steering wheel 310. Steering reaction torque is applied by reaction force actuator 330.

Operation angle sensor 340 detects an operation angle θ [deg] of steering wheel 310 from the rotation angle of steering shaft 320. In other words, operation angle sensor 340 detects the operation amount of the steering operation input member.

Operation angle sensor 340 detects operation angle θ as zero, for example, when steering wheel 310 is at a neutral position. Operation angle sensor 340 detects operation angle θ in a right direction from the neutral position as a positive angle and operation angle θ in a left direction from the neutral position as a negative angle.

Steering device 400 includes a steering actuator 410, a steering member 420, and a steering angle sensor 430. Steering actuator 410 includes a motor 411, a reducer 412, and the like. Motor 411 is a 3-phase brushless motor or the like. Steering member 420 includes a mechanism such as a rack and pinion that converts rotational motion into linear motion. Steering angle sensor 430 detects a steering angle δ of front wheels 101 and 102 (i.e., the turning angle of the front tires) from the position of steering member 420 (e.g., rack bar).

Steering actuator 410 then causes front wheels 101 and 102 to be steered through steering member 420 and steering angle sensor 430 detects steering angle δ [deg] corresponding to the steering amount of steering member 420.

It is to be noted that, when steering angle sensor 430 detects steering angle δ of front wheels 101 and 102 from the position of steering member 420, obtaining steering angular velocity Δδ by differentiating steering angle δ detected by steering angle sensor 430 with respect to time is obtaining steering angular velocity Δδ (i.e., steering speed) from the displacement speed of steering member 420.

In addition, vehicle 100 includes wheel speed sensors 621 to 624 that detect wheel speeds WS1 to WS4. Wheel speeds WS1 to WS4 are the rotation speeds of respective wheels 101 to 104.

Steering control device 500 is an electronic control device including a microcomputer 510 as a main component. Microcomputer 510 includes an MPU (Microprocessor Unit), a ROM (Read Only Memory), and a RAM (Random Access Memory).

Steering control device 500 acquires respective detection signals output from operation angle sensor 340, steering angle sensor 430, and wheel speed sensors 621 to 624.

Steering control device 500 then has a function of a vehicle speed acquisition unit that acquires vehicle speed V [km/h] of vehicle 100, that is, vehicle speed information of vehicle 100 on the basis of pieces of information related to wheel speeds WS1 to WS4 of wheels 101 to 104 respectively output from wheel speed sensors 621 to 624.

It is to be noted that steering control device 500 is capable of obtaining vehicle speed V, for example, from the rotation speed of the drive shaft of driving wheels instead of acquiring vehicle speed V from the outputs of wheel speed sensors 621 to 624.

Microcomputer 510 of steering control device 500 obtains a command signal for steering reaction torque Ts and a command signal for steering angle δ through calculation processing based on pieces of information related to operation angle θ, steering angle δ, vehicle speed V, and the like. In other words, microcomputer 510 of steering control device 500 obtains a target value of steering reaction torque Ts and a target value of steering angle δ.

Microcomputer 510 of steering control device 500 then outputs the command signal for steering reaction torque Ts to reaction force actuator 330 and outputs the command signal for steering angle δ to steering actuator 410, thereby controlling steering reaction torque Ts to be applied to steering wheel 310 and steering angle δ of front wheels 101 and 102.

In addition, vehicle 100 includes a power source 710 such as a motor or an internal combustion engine and a braking device 730 such as a hydraulic brake. Furthermore, vehicle 100 includes a drive control device 720 and a brake control device 740. Drive control device 720 controls power source 710. Brake control device 740 controls braking device 730.

Steering control device 500, drive control device 720, and brake control device 740 communicate with each other through a communication bus 800 of an in-vehicle network.

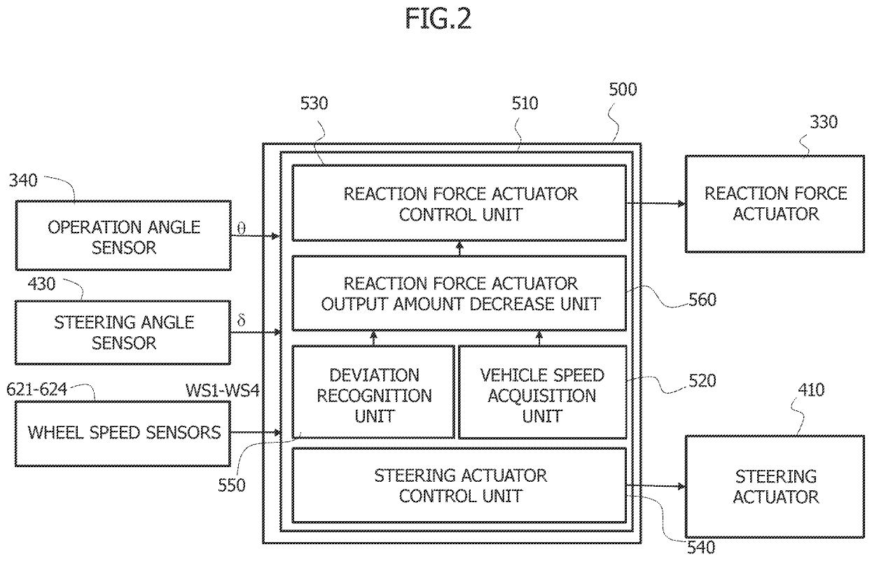

FIG. 2 is a functional block diagram of steering control device 500.

Microcomputer 510 of steering control device 500 has functions of a vehicle speed acquisition unit 520, a reaction force actuator control unit 530, a steering actuator control unit 540, a deviation recognition unit 550, and a reaction force actuator output amount decrease unit 560.

Vehicle speed acquisition unit 520 acquires information related to vehicle speed V of vehicle 100 on the basis of output signals of wheel speed sensors 621 to 624.

Reaction force actuator control unit 530 calculates a command value for steering reaction torque Ts on the basis of pieces of information related to operation angle θ, vehicle speed V, and the like, outputs a command signal for steering reaction torque Ts to reaction force actuator 330, and controls steering reaction torque Ts, that is to say, the output amount of reaction force actuator 330.

Steering actuator control unit 540 outputs a command signal for steering angle δ corresponding to operation angle θ of steering wheel 310 to steering actuator 410 and controls steering actuator 410 in response to an operation on steering wheel 310.

Deviation recognition unit 550 recognizes an angular deviation α [deg] between operation angle θ of steering wheel 310 and steering angle δ of front wheels 101 and 102. Angular deviation α [deg] corresponds to a deviation between the operation amount of the steering operation input member and the steering amount of the steering member.

As described in detail below, reaction force actuator output amount decrease unit 560 decreases steering reaction torque Ts, that is to say, the output amount of reaction force actuator 330 when angular deviation α recognized by deviation recognition unit 550 increases and vehicle speed V of vehicle 100 increases.

Furthermore, reaction force actuator output amount decrease unit 560 decreases steering reaction torque Ts, that is to say, the output amount of reaction force actuator 330 when angular deviation α increases and steering angular velocity Δδ (i.e., the speed of steering by steering device 400) increases.

It is to be noted that reaction force actuator output amount decrease unit 560 obtains steering angular velocity Δδ by differentiating steering angle δ with respect to time.

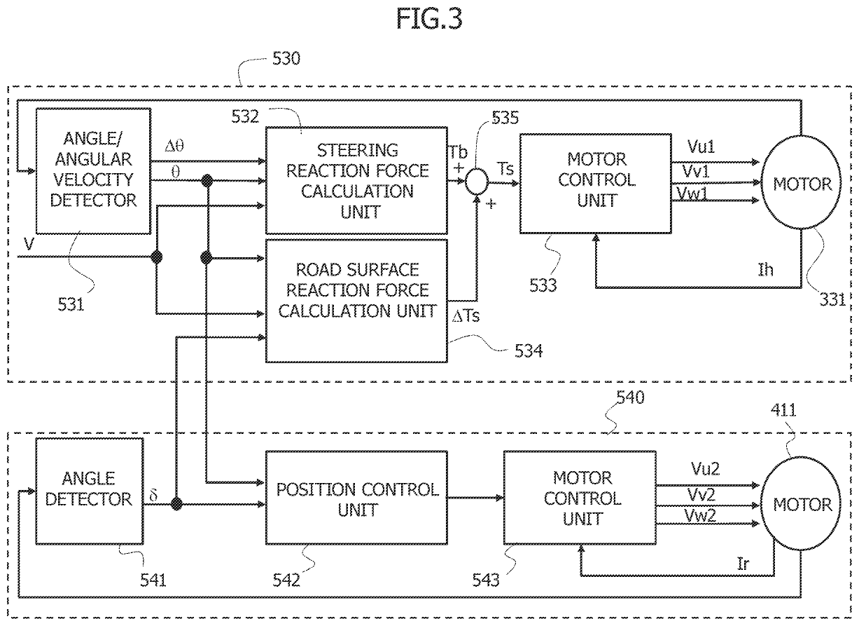

FIG. 3 is a block diagram illustrating processing of controlling steering reaction torque Ts and processing of controlling steering angle δ in steering control device 500.

Steering actuator control unit 540 includes an angle detector 541, a position control unit 542, and a motor control unit 543. Steering actuator control unit 540 performs drive control on motor 411 of steering actuator 410.

Angle detector 541 detects steering angle δ (i.e., steering amount) of front wheels 101 and 102 on the basis of an output signal of steering angle sensor 430.

Position control unit 542 acquires a signal of steering angle δ from angle detector 541 and acquires a signal of operation angle θ of steering wheel 310 from an angle and angular velocity detector 531 described below.

Position control unit 542 calculates a target steering angle δtg on the basis of a detection value of operation angle θ of steering wheel 310 and a setting value of a steering gear ratio Kg and calculates a torque command value of motor 411 to bring a detection value of steering angle δ closer to target steering angle δtg.

Motor control unit 543 controls the energization of motor 411 on the basis of the torque command value acquired from position control unit 542.

Motor control unit 543 compares, for example, a target current corresponding to the torque command value and an actual motor current and performs PWM control on the energization of motor 411.

In addition, reaction force actuator control unit 530 includes angle and angular velocity detector 531, a steering reaction force calculation unit 532, a motor control unit 533, a road surface reaction force calculation unit 534, and an adder 535. Reaction force actuator control unit 530 performs drive control on motor 331 of reaction force actuator 330.

Angle and angular velocity detector 531 detects operation angle θ (operation amount) of steering wheel 310 on the basis of an output signal of operation angle sensor 340. Furthermore, angle and angular velocity detector 531 differentiates information related to operation angle θ with respect to time to detect operation angular velocity Δθ (operation speed).

Steering reaction force calculation unit 532 acquires signals of operation angle θ and operation angular velocity Δθ from angle and angular velocity detector 531 and also acquires a signal of vehicle speed V of vehicle 100.

Steering reaction force calculation unit 532 then calculates basic steering reaction torque Tb [Nm] on the basis of the respective acquired signals and outputs basic steering reaction torque Tb [Nm].

For example, steering reaction force calculation unit 532 sets basic steering reaction torque Tb at a larger value as operation angle θ is larger. In addition, steering reaction force calculation unit 532 sets basic steering reaction torque Tb at a larger value as operation angular velocity Δθ is higher. Furthermore, steering reaction force calculation unit 532 sets basic steering reaction torque Tb at a smaller value as vehicle speed V is lower.

It is to be noted that steering control device 500 acquires operation angle θ and steering angle δ as values each indicating an operation direction with a sign.

In a description of control on steering reaction torque, operation directions are not, however, distinguished by using signs. The description is simplified on the assumption that operation angle θ, operation angular velocity Δθ, steering angle δ, steering angular velocity Δδ, and further steering reaction torque Ts are positive values (i.e., absolute values) regardless of operation directions.

Road surface reaction force calculation unit 534 has functions of deviation recognition unit 550 and reaction force actuator output amount decrease unit 560 as described below.

Road surface reaction force calculation unit 534 acquires pieces of information related to operation angle θ (i.e., the operation amount of steering wheel 310) of steering wheel 310, steering angle δ of front wheels 101 and 102, and vehicle speed V of vehicle 100.

Road surface reaction force calculation unit 534 then obtains angular deviation α between operation angle θ of steering wheel 310 and steering angle δ of front wheels 101 and 102.

In addition, road surface reaction force calculation unit 534 calculates correction torque ΔTs (i.e., kickback torque) on the basis of angular deviation α, vehicle speed V, and steering angular velocity Δδ obtained from steering angle δ. Correction torque ΔTs is for correcting basic steering reaction torque Tb.

Adder 535 adds up basic steering reaction torque Tb acquired from steering reaction force calculation unit 532 and correction torque ΔTs acquired from road surface reaction force calculation unit 534 and outputs a result of the addition to motor control unit 533 as final steering reaction torque Ts.

Motor control unit 533 then controls the energization of motor 331 of reaction force actuator 330 on the basis of a signal (i.e., a command value for the steering reaction torque) of steering reaction torque Ts acquired from adder 535.

Motor control unit 533 compares, for example, a target current corresponding to the torque command value and an actual motor current and performs PWM control on the energization of motor 331.

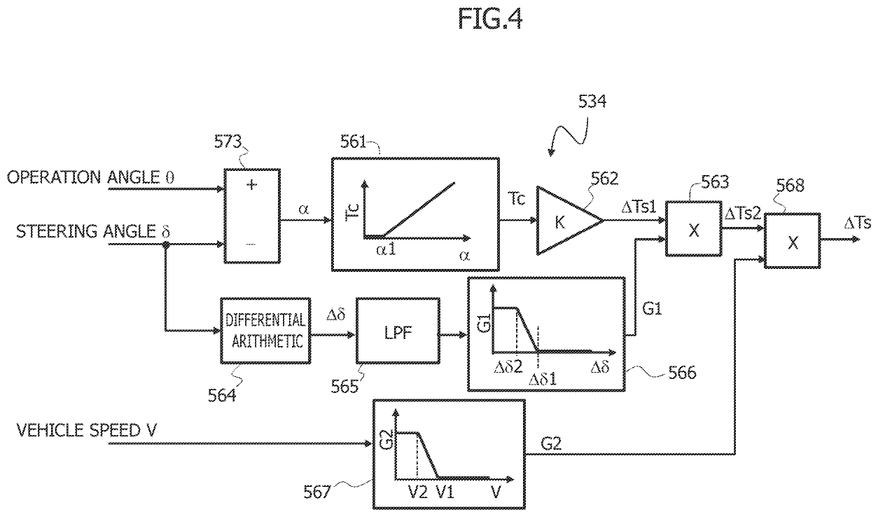

FIG. 4 is a block diagram illustrating road surface reaction force calculation unit 534 in detail.

Road surface reaction force calculation unit 534 includes a conversion processing section 561, a gain 562, a first multiplication section 563, a first differential arithmetic section 564, a first filter section 565, a first gain setting section 566, a second gain setting section 567, and a second multiplication section 568. Furthermore, road surface reaction force calculation unit 534 includes a subtraction section 573 that functions as deviation recognition unit 550. Road surface reaction force calculation unit 534 outputs a signal of correction torque ΔTs (i.e., kickback torque).

Subtraction section 573 (deviation recognition unit 550) calculates angular deviation α [deg] that is a deviation between operation angle θ and steering angle δ.

It is to be noted that subtraction section 573 is considered to calculate angular deviation α as zero when steering angle δ corresponds to operation angle θ.

Conversion processing section 561 converts a signal of angular deviation α acquired from deviation recognition unit 550 to a correction torque control value Tc (Tc≥0) and outputs correction torque control value Tc.

Here, when angular deviation α is less than or equal to a predetermined value α1 (i.e., within a range of a dead zone), conversion processing section 561 sets correction torque control value Tc at zero, thereby preventing steering reaction torque Ts from being corrected to increase (i.e., prevent kickback torque from being applied) in accordance with angular deviation α. In a region where angular deviation α exceeds predetermined value α1, conversion processing section 561 increases correction torque control value Tc in proportion to an increase in angular deviation α.

Predetermined value α1 is a value that defines the dead zone of correction to increase steering reaction torque Ts in accordance with angular deviation α. In other words, predetermined value α1 is a threshold for determining whether angular deviation α increases.

Gain 562 acquires correction torque control value Tc from conversion processing section 561, multiplies correction torque control value Tc by K on the basis of a gain constant K, and outputs the multiplied correction torque control value Tc as a signal of correction torque ΔTs1.

In other words, correction torque ΔTs1 is a value that increases when deviation α increases. For example, when front wheel 101 or 102 abuts an obstacle to increase deviation α, correction torque ΔTs1 increases.

First differential arithmetic section 564 obtains steering angular velocity Δδ that is steering speed by differentiating a signal of steering angle δ.

First filter section 565 acquires a signal of steering angular velocity Δδ from first differential arithmetic section 564 and performs low-pass filter processing of transmitting a low-frequency component of the signal of steering angular velocity Δδ.

First gain setting section 566 acquires the signal of steering angular velocity Δδ transmitted by first filter section 565 and sets a first gain G1 (G1≥0) on the basis of the signal of steering angular velocity Δδ.

Here, when steering angular velocity Δδ is greater than or equal to a first threshold Δδ1, first gain setting section 566 sets first gain G1 at zero. When steering angular velocity Δδ is less than first threshold Δδ1 and greater than or equal to a second threshold Δδ2 (Δδ1>Δδ2), first gain setting section 566 gradually increases first gain G1 in accordance with a decrease in steering angular velocity Δδ. When steering angular velocity Δδ is greater than or equal to zero and less than second threshold Δδ2, first gain setting section 566 sets first gain G1 at a constant value (e.g., 1.0).

First multiplication section 563 multiplies correction torque ΔTs1 acquired from gain 562 by first gain G1 acquired from first gain setting section 566 and outputs a result of the multiplication as correction torque ΔTs2 (ΔTs2=ΔTs1×G1).

Here, when steering angular velocity Δδ is greater than or equal to first threshold Δδ1 and first gain G1 is set at zero, first multiplication section 563 outputs correction torque ΔTs2 as zero (ΔTs2=ΔTs1×0=0).

In addition, when steering angular velocity Δδ is less than second threshold Δδ2 and first gain G1 is set at 1.0, first multiplication section 563 outputs correction torque ΔTs1 as it is as correction torque ΔTs2 (ΔTs2=ΔTs1×1=ΔTs1).

In other words, the multiplication processing by first multiplication section 563 using first gain G1 corresponding to steering angular velocity Δδ is processing of switching between correction torque ΔTs2 set at zero and correction torque ΔTs2=correction torque ΔTs1 in accordance with steering angular velocity Δδ.

When angular deviation α increases and steering angular velocity Δδ increases, the multiplication processing by first multiplication section 563 using first gain G1 then decreases correction torque ΔTs and eventually decreases steering reaction torque Ts.

It is to be noted that road surface reaction force calculation unit 534 is capable of detecting information related to steering speed to be used to set first gain G1 on the basis of wheel speeds instead of obtaining the information from the displacement speed of steering member 420. Described in detail, road surface reaction force calculation unit 534 is capable of detecting the information on the basis of a difference between the left and right wheel speeds.

In short, while vehicle 100 is turning, the left and right tires have different turning radii. This causes a difference between the left and right wheel speeds.

Here, the difference between the left and right wheel speeds depends on the turning angle (e.g., rack position) of the tires. The differential value of the difference between the left and right wheel speeds thus depends on the displacement speed of the rack bar.

It is thus possible for road surface reaction force calculation unit 534 to obtain the steering speed by calculating the difference between the left and right wheel speeds and differentiating the difference between the left and right wheel speeds and use the steering speed to set first gain G1.

Second gain setting section 567 acquires a signal of vehicle speed V of vehicle 100 and sets a second gain G2 (G2≥0) on the basis of the signal of vehicle speed V.

Here, when vehicle speed V is greater than or equal to a first threshold V1, second gain setting section 567 sets second gain G2 at zero. When vehicle speed V is less than first threshold V1 and greater than or equal to a second threshold V2 (V1>V2), second gain setting section 567 gradually increases second gain G2 in accordance with a decrease in vehicle speed V. When vehicle speed V is greater than or equal to zero and less than second threshold V2, second gain setting section 567 sets second gain G2 at a constant value (e.g., 1.0).

Second multiplication section 568 multiplies correction torque ΔTs2 acquired from first multiplication section 563 by second gain G2 acquired from second gain setting section 567 and outputs a result of the multiplication as final correction torque ΔTs (ΔTs=ΔTs2×G2=ΔTs1×G1×G2).

Final correction torque ΔTs is thus set at zero (ΔTs=ΔTs2×0=0) as long as vehicle speed V is greater than or equal to first threshold V1 and second gain G2 is set at zero even if correction torque ΔTs2 calculated by first multiplication section 563 is a value exceeding zero (ΔTs2>0).

In addition, when vehicle speed V is less than second threshold V2 and second gain G2 is set at 1.0, second multiplication section 568 outputs correction torque ΔTs2 as it is as final correction torque ΔTs (ΔTs=ΔTs2×1=ΔTs2).

In other words, the multiplication processing by second multiplication section 568 using second gain G2 corresponding to vehicle speed V is processing of switching between correction torque ΔTs set at zero and correction torque ΔTs=correction torque ΔTs2 in accordance with vehicle speed V.

When angular deviation α increases and vehicle speed V increases, the multiplication processing by second multiplication section 568 using second gain G2 then decreases correction torque ΔTs and eventually decreases steering reaction torque Ts.

When, for example, a collision of front wheel 101 or 102 with an obstacle such as a curb on a road shoulder or other factors at the time of the vehicle having high vehicle speed causes angular deviation α to increase and this increases correction torque ΔTs and applies great steering reaction torque Ts to steering wheel 310, steering wheel 310 may abruptly move, shocking the driver.

Road surface reaction force calculation unit 534 thus cancels correction to increase steering reaction torque Ts by correction torque ΔTs (i.e., angular deviation α) and prevents steering wheel 310 from abruptly moving, shocking the driver within a middle and high vehicle speed range within which increased steering reaction torque Ts may abruptly move steering wheel 310, shocking the driver.

Here, focus is placed on a change in steering reaction torque Ts. Road surface reaction force calculation unit 534 decreases steering reaction torque Ts when angular deviation α increases and vehicle speed V increases. This prevents steering reaction torque Ts from abruptly moving steering wheel 310, shocking the driver, for example, when front wheel 101 or 102 has a collision with an obstacle such as a curb on a road shoulder within the middle and high vehicle speed range.

In contrast, road surface reaction force calculation unit 534 enables correction to increase steering reaction torque Ts by correction torque ΔTs as second gain G2>0 (e.g., second gain G2=1.0) and informs the driver of the road surface situation through kickback torque when vehicle speed V is greater than or equal to zero and less than second threshold V2.

In addition, road surface reaction force calculation unit 534 prevents steering reaction torque Ts from abruptly changing along with a change in vehicle speed V by gradually changing second gain G2 in a region in which vehicle speed V is less than first threshold V1 and greater than or equal to second threshold V2.

In addition, a delay in response of steering angle δ to operation angle θ also causes angular deviation α to increase when the driver intentionally greatly jerks steering wheel 310.

When the driver intentionally greatly jerks steering wheel 310, the application of kickback torque to steering wheel 310 then causes the driver to experience a strange sensation.

Road surface reaction force calculation unit 534 thus determines, on the basis of steering angular velocity Δδ, whether steering angle δ is following the intentional operation of the driver on steering wheel 310 or whether front wheel 101 or 102 abuts an obstacle and road surface reaction force calculation unit 534 controls steering reaction torque Ts.

If described in detail, road surface reaction force calculation unit 534 determines that steering angle δ is following an operation on steering wheel 310 when steering angular velocity Δδ is greater than or equal to first threshold Δδ1.

If steering angle δ is following an operation on steering wheel 310, road surface reaction force calculation unit 534 then cancels correction to increase steering reaction torque Ts by correction torque ΔTs (i.e., angular deviation α), that is to say, the application of kickback torque by setting first gain G1 at zero and prevents the driver from experiencing a strange sensation.

Here, focus is placed on a change in steering reaction torque Ts. Road surface reaction force calculation unit 534 decreases steering reaction torque Ts when angular deviation α increases and steering angular velocity Δδ increases, thereby preventing the driver from experiencing a strange sensation when the driver intentionally greatly jerks steering wheel 310.

In addition, road surface reaction force calculation unit 534 enables correction to increase steering reaction torque Ts by correction torque ΔTs as first gain G1>0 (e.g., first gain G1=1.0) and informs the driver of the road surface situation through kickback torque when steering angular velocity Δδ is greater than or equal to zero and less than second threshold Δδ2.

In addition, road surface reaction force calculation unit 534 prevents steering reaction torque Ts from abruptly changing along with a change in steering angular velocity Δδ by gradually changing first gain G1 in a region in which steering angular velocity Δδ is less than first threshold Δδ1 and greater than or equal to second threshold Δδ2.

Next, a second embodiment will be described in which road surface reaction force calculation unit 534 additionally has a function of decreasing correction torque ΔTs in accordance with operation angular velocity Δθ, that is, the operation speed of steering operation input member.

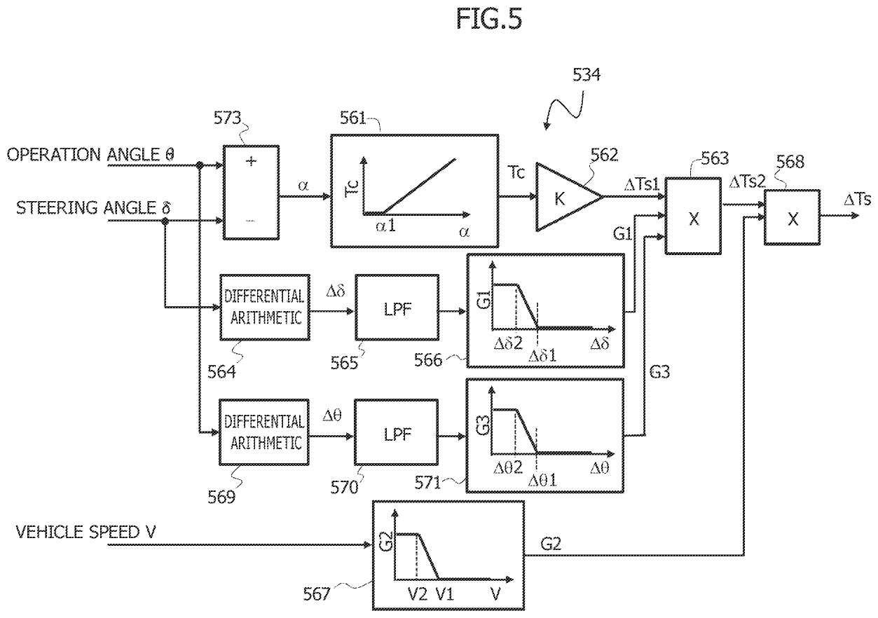

FIG. 5 is a block diagram illustrating road surface reaction force calculation unit 534 according to the second embodiment.

It is to be noted that the same elements in FIG. 5 as those in FIG. 4 are denoted with the same reference numerals. The same elements as those in FIG. 4 will not be described in detail.

Road surface reaction force calculation unit 534 in FIG. 5 includes a second differential arithmetic section 569, a second filter section 570, and a third gain setting section 571 in addition to subtraction section 573, conversion processing section 561, gain 562, first multiplication section 563, first differential arithmetic section 564, first filter section 565, first gain setting section 566, second gain setting section 567, and second multiplication section 568 that have been described above.

Second differential arithmetic section 569 obtains operation angular velocity Δθ, that is to say, the operation speed of steering wheel 310 by differentiating a signal of operation angle θ.

Second filter section 570 acquires a signal of operation angular velocity Δθ from second differential arithmetic section 569 and performs low-pass filter processing of transmitting a low-frequency component of the signal of operation angular velocity M.

Third gain setting section 571 acquires the signal of operation angular velocity Δθ transmitted by second filter section 570 and sets a third gain G3 (G3≥0) on the basis of the signal of operation angular velocity Δθ.

Here, when operation angular velocity Δθ is greater than or equal to a first threshold Δθ1, third gain setting section 571 sets third gain G3 at zero. When operation angular velocity Δθ is less than first threshold Δθ1 and greater than or equal to a second threshold Δθ2 (Δθ1>Δθ2), third gain setting section 571 gradually increases third gain G3 in accordance with a decrease in operation angular velocity Δθ. When operation angular velocity Δθ is greater than or equal to zero and less than second threshold Δθ2, third gain setting section 571 sets third gain G3 at a constant value (e.g., 1.0).

First multiplication section 563 then multiplies correction torque ΔTs1 acquired from gain 562 by first gain G1 acquired from first gain setting section 566 and third gain G3 acquired from third gain setting section 571 and outputs a result of the multiplication as correction torque ΔTs2 (ΔTs2=ΔTs1×G1×G3).

Here, when operation angular velocity Δθ is greater than or equal to first threshold Δθ1 and third gain G3 is set at zero, first multiplication section 563 outputs correction torque ΔTs2 as zero (ΔTs2=ΔTs1×G1×0=0).

In addition, when operation angular velocity Δθ is less than second threshold Δθ and third gain G3 is set at 1.0, first multiplication section 563 cancels processing of changing correction torque ΔTs2 in accordance with operation angular velocity Δθ and correction torque ΔTs2 is set depending on angular deviation α and steering angular velocity Δδ.

In other words, the multiplication processing by first multiplication section 563 using third gain G3 corresponding to operation angular velocity Δθ is processing of switching between correction torque ΔTs2 set at zero and correction torque ΔTs2=ΔTs1×G1 in accordance with operation angular velocity Δθ.

When angular deviation α increases and operation angular velocity Δθ increases, the multiplication processing by first multiplication section 563 using third gain G3 then decreases correction torque ΔTs and eventually decreases steering reaction torque Ts.

Operation angular velocity Δθ greater than or equal to first threshold Δθ1 means that a driver is intentionally operating steering wheel 310. A delay in response of steering angle δ to the operation of the driver on steering wheel 310 brings about angular deviation α.

Road surface reaction force calculation unit 534 thus sets third gain G3 at zero when operation angular velocity Δθ is greater than or equal to first threshold Δθ1 and it is estimated that the driver is intentionally operating steering wheel 310. Road surface reaction force calculation unit 534 hereby sets correction torque ΔTs at zero, cancels correction to increase steering reaction torque Ts in accordance with angular deviation α, and prevents the driver from experiencing a strange sensation because of applied kickback torque.

In contrast, when operation angular velocity Δθ is less than second threshold Δθ2, road surface reaction force calculation unit 534 sets third gain G3>0 (e.g., G3=1.0), enables correction to increase steering reaction torque Ts by correction torque ΔTs, and permits the driver to be informed of the road surface situation through kickback torque.

In addition, road surface reaction force calculation unit 534 prevents steering reaction torque Ts from abruptly changing along with a change in operation angular velocity Δθ by gradually changing third gain G3 in a region in which operation angular velocity Δθ is less than first threshold Δθ1 and greater than or equal to second threshold Δθ2.

Incidentally, it is possible to change, in accordance with vehicle speed V of vehicle 100, predetermined value α1 that is a threshold in conversion processing section 561 for determining whether angular deviation α increases. In other words, it is possible to change the size of the dead zone of the correction of steering reaction torque Ts corresponding to angular deviation α in accordance with vehicle speed V of vehicle 100.

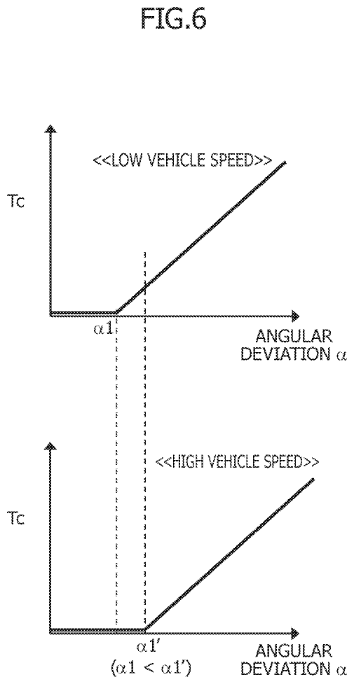

FIG. 6 is a diagram illustrating a change in predetermined value α1 relative to vehicle speed V. In short, FIG. 6 is a diagram illustrating a changing dead zone.

In FIG. 6, when angular deviation α is less than or equal to predetermined value α1, correction torque control value Tc is set at zero. A range within which angular deviation α is less than or equal to predetermined value α1 serves as a dead zone of correction control on steering reaction torque Ts corresponding to angular deviation α. In other words, the range serves as a dead zone of kickback torque setting.

Angular deviation α exceeding predetermined value α1 then causes correction control to be performed on steering reaction torque Ts in accordance with angular deviation α. Angular deviation α exceeding predetermined value α1 means substantially increased angular deviation α.

Here, conversion processing section 561 increases predetermined value α1 as vehicle speed V increases. Conversion processing section 561 widens the dead zone as vehicle speed V increases.

If steering reaction torque Ts is corrected to increase by angular deviation α at the time of high vehicle speed V and steering wheel 310 is shaken by applied steering reaction torque Ts, traveling stability can be impaired.

Conversion processing section 561 thus increases predetermined value α1 to widen the dead zone as vehicle speed V is higher. This decreases the degree to which steering reaction torque Ts increases in response to angular deviation α and prevents steering wheel 310 from being shaken by applied steering reaction torque Ts at high vehicle speed V.

It is possible to appropriately use the respective technical ideas described in the embodiments in combination as long as inconsistency is avoided.

In addition, the contents of the present invention have been specifically described with reference to the preferred embodiments, but it would be obvious to those skilled in the art that a variety of modifications may be adopted on the basis of the basic technical ideas and teachings of the present invention.

For example, in the embodiments described above, road surface reaction force calculation unit 534 gradually decreases first gain G1 in response to an increase in steering angular velocity Δδ, gradually decreases second gain G2 in response to an increase in vehicle speed V, and further gradually decreases third gain G3 in response to an increase in operation angular velocity Δθ.

This configuration is not, however, limiting. Road surface reaction force calculation unit 534 is capable of making a step change in first gain G1 at a threshold of steering angular velocity Δδ, making a step change in second gain G2 at a threshold of vehicle speed V, and making a step change in third gain G3 at a threshold of operation angular velocity Δθ.

In other words, road surface reaction force calculation unit 534 is capable of setting, for example, first gain G1 at zero when steering angular velocity Δδ is greater than or equal to a threshold Δδth and setting first gain G1 at a constant value (e.g., 1.0) when steering angular velocity Δδ is less than threshold Δδth.

Here, processing of switching the gain between 1 and zero corresponds to processing of selectively outputting any one of correction torque ΔTs1 or correction torque ΔTs2 and zero. Processing of calculating correction torque ΔTs is not limited to the calculation of multiplication by a gain.

Furthermore, road surface reaction force calculation unit 534 is capable of using, in combination, gains that gradually decrease in response to increases in vehicle speed V, steering angular velocity Δδ, and operation angular velocity Δθ and gains that undergo step changes in response to increases in the state quantities of steering angular velocity Δδ and the like.

In addition, in the embodiments described above, road surface reaction force calculation unit 534 decreases respective gains G1, G2, and G3 to zero in response to increases in the state quantities of steering angular velocity Δδ and the like. However, it is sufficient if road surface reaction force calculation unit 534 makes changes to decrease the gains in response to increases in the state quantities of steering angular velocity Δδ and the like. The configuration is not limiting in which the gains decrease to zero.

Here, the following describes technical ideas that would be obvious from the embodiments described above.

A steer-by-wire type steering apparatus according to an aspect is a steer-by-wire type steering apparatus that is attached to a vehicle. The steer-by-wire type steering apparatus includes a steering input device, a steering device, and a control device. The steering input device includes a steering operation input member, and a reaction force actuator configured to apply given steering reaction force to the steering operation input member. The steering device includes a steering member, and a steering actuator configured to cause steered road wheels to be steered through the steering member. The control device includes a vehicle speed acquisition unit configured to acquire vehicle speed information of the vehicle, a reaction force actuator control unit configured to control an output amount of the reaction force actuator, a steering actuator control unit configured to control the steering actuator in response to an operation on the steering operation input member, a deviation recognition unit configured to recognize a deviation between an operation amount of the steering operation input member and a steering amount of the steering member, and a road surface reaction force calculation unit configured to increase the output amount of the reaction force actuator controlled by the reaction force actuator control unit when the deviation recognized by the deviation recognition unit increases and decrease an amount of increase in the output amount of the reaction force actuator corresponding to the deviation when vehicle speed of the vehicle increases.

In another preferred aspect, the road surface reaction force calculation unit further decreases the amount of increase in the output amount of the reaction force actuator corresponding to the deviation when speed of steering by the steering device increases.

Furthermore, in another preferred aspect, the road surface reaction force calculation unit further decreases the amount of increase in the output amount of the reaction force actuator corresponding to the deviation when operation speed of the steering operation input member increases.

### REFERENCE SYMBOL LIST

100 vehicle
101 to 104 wheels (tires)
200 steer-by-wire type steering apparatus
300 steering input device
310 steering wheel (steering operation input member)
330 reaction force actuator
331 motor
340 operation angle sensor
400 steering device
410 steering actuator
411 motor
420 steering member
430 steering angle sensor
500 steering control device (control device)
520 vehicle speed acquisition unit
530 reaction force actuator control unit
540 steering actuator control unit
550 deviation recognition unit
560 reaction force actuator output amount decrease unit

1. A steer-by-wire type steering apparatus that is attached to a vehicle, the steer-by-wire type steering apparatus comprising:
a steering input device including
a steering operation input member, and
a reaction force actuator configured to apply given steering reaction force to the steering operation input member;
a steering device including
a steering member, and
a steering actuator configured to cause steered road wheels to be steered through the steering member; and
a control device including
a vehicle speed acquisition unit configured to acquire vehicle speed information of the vehicle,
a reaction force actuator control unit configured to control an output amount of the reaction force actuator,
a steering actuator control unit configured to control the steering actuator in response to an operation on the steering operation input member,
a deviation recognition unit configured to recognize a deviation between an operation amount of the steering operation input member and a steering amount of the steering member, and
a reaction force actuator output amount decrease unit configured to decrease the output amount of the reaction force actuator when the deviation recognized by the deviation recognition unit increases and vehicle speed of the vehicle increases, the output amount being controlled by the reaction force actuator control unit.

2. The steer-by-wire type steering apparatus according to claim 1, wherein the reaction force actuator output amount decrease unit further decreases the output amount of the reaction force actuator when the deviation recognized by the deviation recognition unit increases and speed of steering by the steering device increases, the output amount being controlled by the reaction force actuator control unit.

3. The steer-by-wire type steering apparatus according to claim 1, wherein the reaction force actuator output amount decrease unit further decreases the output amount of the reaction force actuator when the deviation recognized by the deviation recognition unit increases and operation speed of the steering operation input member increases, the output amount being controlled by the reaction force actuator control unit.

4. The steer-by-wire type steering apparatus according to claim 2, wherein the reaction force actuator output amount decrease unit detects the speed of steering by the steering device on a basis of displacement speed of the steering member.

5. The steer-by-wire type steering apparatus according to claim 2, wherein the reaction force actuator output amount decrease unit detects the speed of steering by the steering device on a basis of a difference between wheel speeds of the left and right steered road wheels.

6. The steer-by-wire type steering apparatus according to claim 1, wherein the reaction force actuator output amount decrease unit changes, in accordance with the vehicle speed of the vehicle, a threshold for determining whether the deviation increases.
